(19) United States
(12) Patent Application Publication
(10) Pub. No.: US 2026/0228281 A1
(43) Pub. Date: Aug. 6, 2026

(54) ENTITY DISCOVERY BASED ON GLOSSARY DATA

(71) Applicant: HITACHI VANTARA LLC, Santa Clara, CA (US)

(72) Inventors: Vilayannur Ramachandran SITARAMAN, Seattle, WA (US); Leon BURDA, Cupertino, CA (US); Shayak SADHU, Bansberia (IN); Venkat SUBRAMANIAN, Saratoga, CA (US); LingLing YAN, Hollister, CA (US)

(21) Appl. No.: 19/106,255

(22) PCT Filed: Aug. 26, 2022
(86) PCT No.: PCT/US2022/041613

§ 371 Date: Feb. 25, 2025

(51) Int. Cl. G06F 16/901; G06F 16/21; G06F 16/22; G06F 18/22

(52) U.S. Cl. CPC G06F 16/9024; G06F 16/211; G06F 16/2246; G06F 18/22

(57) ABSTRACT

In some examples, a system receives a tree data structure representing tags arranged in a hierarchy indicating a business level of abstraction. The system performs field-level classification of data to obtain field tags related to the data, and may generate a graph data structure by comparing field tags of the data to a set of child tags of the tree. The system creates a node in the graph for the parent tag of the set of child tags and creates a node for a data resource corresponding to the compared field tags. Based on the comparing and/or one or more entity relationships, the system creates a directed edge from the resource node to the parent tag, and repeats the comparing and the creating for a plurality of the parent tags and the resources. The system executes a ranking algorithm to identify at least one parent tag as a target entity.

### TECHNICAL FIELD

This disclosure relates to the technical field of storing, classifying, and accessing data, such as in systems that store large amounts of data.

### BACKGROUND

A data catalog may include an assemblage of metadata that can provide an organization with additional information about data sources and other data assets of the organization. The data catalog may thereby enable the organization to obtain additional value from its data assets. The metadata in the data catalog may include data that describes a data asset or otherwise provides information about the data asset, such as by making the data asset easier to locate, evaluate, and/or understand. For instance, a data catalog may assist users in efficiently locating the most applicable data for analytical or other desired purposes.

Furthermore, a glossary may be associated with the data catalog. The glossary may include a collection of terms, phrases, concepts, etc., that define characteristics of the organization's data. For instance when creating, augmenting, or otherwise maintaining a glossary, it is typically desirable for a glossary to be well organized, searchable, and configured to make data visible to users, while also providing for consistency in data governance. Thus, the data catalog may provide an inventory of the organization's data assets, while the glossary may define and contextualize the organization's data assets.

### SUMMARY

Some examples herein include a system that receives a tree data structure representing tags arranged in a hierarchy indicating a business level of abstraction. The system performs a field-level classification of data to obtain field tags related to the data, and may generate a graph data structure by comparing field tags of the data to a set of child tags of the tree. The system creates a node in the graph for the parent tag of the set of child tags and creates a node for a data resource corresponding to the compared field tags. Based on an amount of matching between the child tags of the tree and the field tags identified in the resource and/or based on one or more entity relationships, the system creates a directed edge from the resource node to the parent tag; and repeats the comparing and the creating for a plurality of the parent tags and the resources. The system executes a ranking algorithm to identify at least one parent tag as a target entity.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example architecture of a system able to identify target entities in data according to some implementations.

FIG. 2 is a flow diagram illustrating an example process for identifying target entities according to some implementations.

FIG. 3 illustrates an example of comparing a glossary target entity parent tag with a selected resource according to some implementations.

FIG. 4 illustrates an example of creating a portion of the evidence graph based on a relationship determined from a database schema according to some implementations.

FIG. 5 illustrates an example evidence graph portion according to some implementations.

FIG. 6 illustrates an example evidence graph that may be constructed according to implementations herein.

FIG. 7 illustrates an example output of applying the PageRank algorithm to the evidence graph of FIG. 6 according to some implementations.

FIG. 8 illustrates an example user interface for managing the glossary herein according to some implementations.

### DESCRIPTION OF THE EMBODIMENTS

Some implementations herein are directed to techniques and arrangements for employing a glossary and/or employing entity relationships available within an organization's data for identifying target entities within the glossary automatically. Examples herein may rank the glossary terms, resources, and/or tables based on a number of pointed-to relationships in the data, such as may be represented by an evidence graph. In particular, the higher ranking nodes in the evidence graph may correspond to the target entities. Tagging may be performed automatically and a correspondence between nodes may be determined based on an intersection score of the tag names with those of the glossary.

In some cases, the glossary on which the mapping is performed, and from which the graph is constructed, may be generated or otherwise provided by a user or the like. Further, the target entities may be business entities and may correspond to those glossary elements that exceed a page rank threshold. Thus, the implementations herein are able to identify the target entities using the techniques described herein, rather than performing these tasks manually or by using hard-coded rules. The identification of the target entities be performed automatically based on the glossary definition and the mapping to the data.

In some examples, for identifying the target entities in the organization's data and glossary, the system may initially perform a context-free, generous data classification of all fields. For instance, this initial round of classification might not be particularly accurate and does not represent the final classification results. The system may build a weighted evidence graph that encodes evidence from the organization's data that a term corresponds to a target entity term. Details of building the evidence graph are discussed additionally below. Further, following construction of the evidence graph, the system may use a variation of the PageRank algorithm for ranking the nodes in the evidence graph to identify entity terms, and may select one or more of the highest-ranked results as the target entity.

As a specific example, suppose that a user of the data catalog desires to identify business entities present in the data and glossary of an organization. In this example, business entities are conceptual level abstractions that may be reflected in the data layout such as in terms of groupings of tags in a data resource or in terms of an entity relationship diagram schema. For instance, identification of business entities in what may be a very large amount of data is a non-trivial task that cannot practically be accomplished in the human mind or with a pen and paper. Additionally, identifying business entities in the organization's data adds value to the data cataloging solution. In particular, identifying the business entities in the glossary allows the organization to classify data at the resource level, and also provides context for more accurate field-level data classification. Thus, identifying business entities enables more powerful searching in the data catalog, such as by enabling resources to be searched based on business entity tags.

In addition, identifying business entities in the data catalog enables the data catalog to provide context for other downstream cataloging tasks such as for the disambiguation of ambiguous tags. As one example, three-digit numbers are inherently anonymous and therefore could potentially be tagged with a multitude of tags, but if a particular three-digit number is associated with an identified business entity, such as a credit card transaction, this provides context to the three digit number and therefore can be used to avoid the association of ambiguous tags with the particular three digit number and, e.g., associate the three digit number only with a CVV (card verification value) number tag in the said example. Thus, identified business entities can serve as a context for more accurate field-level classification of other data.

For discussion purposes, some example implementations are described in the environment of one or more service computing devices in communication with one or more storages and one or more client devices, and configured to identify target entities in large amounts of data and/or in a corresponding glossary. However, implementations herein are not limited to the particular examples provided, and may be extended to other types of computing systems, other types of storage environments, other system architectures, other types of entities, other types of storage repositories, and so forth, as will be apparent to those of skill in the art in light of the disclosure herein.

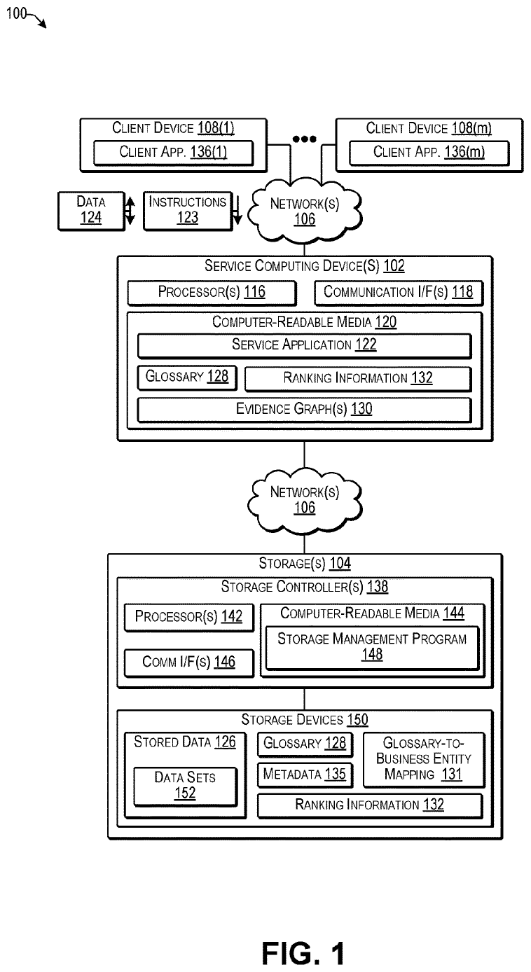

FIG. 1 illustrates an example architecture of a system 100 able to identify target entities in data according to some implementations. The system 100 includes one or more service computing devices 102 that are able to communicate with one or more storages 104 through one or more networks 106. In addition, the service computing device(s) 102 may also be able to communicate over the one or more networks 106 with a plurality of client devices 108(1)-108(m), such as user devices or other devices that may communicate with the service computing devices 102. For example, the system 100 may store, classify, and manage data for the client devices 108, e.g., as a data storage, data catalog, data repository, database, data warehouse, or the like.

In some examples, the service computing devices 102 may include a plurality of physical servers or other types of computing devices that may be embodied in any number of ways. For instance, in the case of a server, the programs, applications, modules, other functional components, and a portion of data storage may be implemented on the servers, such as in a cluster of servers, e.g., at a server farm or data center, a cloud-hosted computing service, and so forth, although other computer architectures may additionally or alternatively be used. In the illustrated example, each service computing device 102 may include, or may have associated therewith, one or more processors 116, one or more communication interfaces 118, and one or more computer-readable media 120. Further, while a description of one service computing device 102 is provided, the other service computing devices 102 may have the same or similar hardware and software configurations and components.

Each processor 116 may be a single processing unit or a number of processing units, and may include single or multiple computing units or multiple processing cores. The processor(s) 116 can be implemented as one or more central processing units, microprocessors, microcomputers, microcontrollers, digital signal processors, graphics processing units, state machines, logic circuitries, and/or any devices that manipulate signals based on operational instructions. For instance, the processor(s) 116 may be one or more hardware processors and/or logic circuits of any suitable type specifically programmed or configured to execute the algorithms and processes described herein. The processor(s) 116 can be configured to fetch and execute computer-readable instructions stored in the computer-readable media 120, which can program the processor(s) 116 to perform the functions described herein.

The computer-readable media 120 may include volatile and nonvolatile memory and/or removable and non-removable media implemented in any type of technology for storage of information such as computer-readable instructions, data structures, program modules, or other data. For example, the computer-readable media 120 may include, but is not limited to, RAM, ROM, EEPROM, flash memory or other memory technology, optical storage, solid state storage, magnetic disk storage, magnetic tape, storage arrays, network attached storage, storage area networks, cloud storage, or any other medium that can be used to store the desired information and that can be accessed by a computing device. Depending on the configuration of the service computing device 102, the computer-readable media 120 may be a tangible non-transitory medium to the extent that, when mentioned, non-transitory computer-readable media exclude media such as energy, carrier signals, electromagnetic waves, and/or signals per se. In some cases, the computer-readable media 120 may be at the same location as the service computing device 102, while in other examples, the computer-readable media 120 may be separate or partially remote from the service computing device 102.

The computer-readable media 120 may be used to store any number of functional components that are executable by the processor(s) 116. In many implementations, these functional components comprise instructions, applications, or other programs that are executable by the processor(s) 116 and that, when executed, specifically program the processor(s) 116 to perform the actions attributed herein to the service computing device 102. Functional components stored in the computer-readable media 120 may include a service application 122, which may include one or more computer programs, applications, executable code, computer-readable instructions, or portions thereof. For example, the service application 122 may be executed by the processors(s) 116 for identifying target entities in data, as well as for performing various other data classification tasks, data storage and retrieval tasks, such as for interacting with the client devices 108, responding to instructions 123 from the client devices, storing data 124 for the client devices in the storage 104, retrieving data 124 for the client devices 108, and/or for providing the client devices 108 with access to stored data 126 stored in the storage 104. Thus, the service application 122 may configure the service computing device(s) 102 to provide one or more services to the client computing devices 108. In some cases, the functional component(s) may be stored in a storage portion of the computer-readable media 120, loaded into a local memory portion of the computer-readable media 120, and executed by the one or more processors 116.

In addition, the computer-readable media 120 may store data and data structures used for performing the functions and services described herein. For example, the computer-readable media 120 may store data, metadata, data structures, and/or other information generated by and/or used by the service application 122. For instance, the service computing device(s) 102 may store and manage a glossary 128, evidence graph(s) 130, and ranking information 132, as discussed additionally below. As additionally, or alternatively, the glossary 128, the evidence graph(s) 130 and/or the ranking information 132 may be stored at the storage(s) 104. Further, a glossary-to-business-entity mapping 131 may be stored on the computer-readable media 120 and/or at the storage 104.

Each service computing device 102 may also include or maintain other functional components and data, which may include an operating system, programs, drivers, etc., and other data used or generated by the functional components are. Further, the service computing device(s) 102 may include many other logical, programmatic, and physical components, of which those described above are merely examples that are related to the discussion herein. Additionally, numerous other software and/or hardware configurations will be apparent to those of skill in the art having the benefit of the disclosure herein, with the foregoing being merely one example provided for discussion purposes.

The communication interface(s) 118 may include one or more interfaces and hardware components for enabling communication with various other devices, such as over the network(s) 106. Thus, the communication interfaces 118 may include, or may couple to, one or more ports that provide connection to the one or more network(s) 106 for communication with the storage(s) 104 and the client device(s) 108. For example, the communication interface(s) 118 may enable communication through one or more of a LAN (local area network), WAN (wide area network), the Internet, cable networks, cellular networks, wireless networks (e.g., Wi-Fi) and wired networks (e.g., Fibre Channel, fiber optic, Ethernet), direct connections, as well as close-range communications such as BLUETOOTH®, and the like, as additionally enumerated elsewhere herein. In addition, for increased fault tolerance, the communication interfaces 118 of the service computing device(s) 102 may include redundant network connections to each of the network(s) 106 to which the service computing device(s) 102 is coupled.

The network(s) 106 may include any suitable communication technology, including a WAN, such as the Internet; a LAN, such as an intranet; a wireless network, such as a cellular network, a local wireless network, such as Wi-Fi, and/or a short-range wireless communications, such as BLUETOOTH®; a wired network including Fibre Channel, fiber optics, Ethernet, or any other such network, a direct wired connection, or any combination thereof. Thus, the network(s) 106 may include wired and/or wireless communication technologies. Components used for the network(s) 106 can depend at least in part upon the type of network, the environment selected, desired performance, and the like. The protocols for communicating over the network(s) 106 herein are well known and will not be discussed in detail. Accordingly, the service computing device(s) 102 is able to communicate with the storage(s) 104 and the client device(s) 108 over the network(s) 106 using wired and/or wireless connections, and combinations thereof.

Each client device 108 may be any suitable type of computing device such as a desktop, workstation, server, laptop, tablet computing device, mobile device, smart phone, wearable computing device, or any other type of computing device able to send data over a network. For instance, the client device(s) 108 may generate data 124 that is sent to the service computing device(s) 102 for data storage, backup storage, long term remote storage, or any other sort of data storage. In some cases, the client device(s) 108 may include hardware configurations similar to that described for the service computing device 102, but with different data and functional components to enable the client device(s) 108 to perform the various functions discussed herein. In some examples, a user may be associated with a respective client device 108, such as through a user account, user login credentials, or the like. In some examples, the client devices 108 may include servers of the organization that may generate, aggregate, receive or otherwise provide data 124 to the service computing device(s) 102 for storage and cataloging.

Each client device 108(1)-108(m) may access one or more of the service computing devices 102 through a respective instance of a client application 136(1)-136(m), such as a browser, a web application, or other type of application executed on the client device 108. For instance, the client application 136 may provide a graphical user interface (GUI), a command line interface, and/or may employ an application programming interface (API) for communicating with the service application 122 on a service computing device 102. Furthermore, while one example of a client-server configuration is described herein, numerous other possible variations and applications for the computing system 100 herein will be apparent to those of skill in the art having the benefit of the disclosure herein.

The storage(s) 104 may provide storage capacity for the system 100 for storage of data, such as file data or other object data, and which may include data content and metadata about the content. The storage(s) 104 may include storage arrays such as network attached storage (NAS) systems, storage area network (SAN) systems, cloud storage, storage virtualization systems, or the like. Further, the storage(s) 104 may be co-located with one or more of the service computing devices 102, or may be remotely located or otherwise external to the service computing device(s) 102.

In the illustrated example, the storage(s) 104 includes one or more storage computing devices referred to as storage controller(s) 138, which may include one or more servers or any other suitable computing devices, such as any of the examples discussed above with respect to the service computing device 102. The storage controller(s) 138 may each include one or more processors 142, one or more computer-readable media 144, and one or more communication interfaces 146. For example, the processor(s) 142 may correspond to any of the examples discussed above with respect to the processors 116, the computer-readable media 144 may correspond to any of the examples discussed above with respect to the computer-readable media 120, and the communication interfaces 146 may correspond to any of the examples discussed above with respect to the communication interfaces 118.

Further, the computer-readable media 144 of the storage controller 138 may be used to store any number of functional components that are executable by the processor(s) 142. In many implementations, these functional components comprise instructions, modules, or programs that are executable by the processor(s) 142 and that, when executed, specifically program the processor(s) 142 to perform the actions attributed herein to the storage controller 138. Functional components stored in the computer-readable media 144 may include a storage management program 148, which may include one or more computer programs, applications, executable code, computer-readable instructions, or portions thereof. For example, the storage management program 148 may control or otherwise manage the storage of the stored data 126 in a plurality of storage devices 150 coupled to the storage controller 138.

In some cases, the storage devices 150 may include one or more arrays of physical storage devices. For instance, the storage controller 138 may control one or more arrays, such as for configuring the arrays in a RAID (redundant array of independent disks) configuration or any other desired storage configuration. In some examples, the storage controller 138 may present logical units based on the physical devices to the service computing devices 102, and may manage the data stored on the underlying physical devices. The storage devices 150 may include any type of storage device, such as hard disk drives, solid state devices, optical devices, magnetic tape, and so forth, or combinations thereof. Alternatively, in other examples, one or more of the service computing devices 102 may act as the storage controller, and the storage controller 138 may be eliminated.

In the illustrated example, the service computing device(s) 102 and storage(s) 104 may be configured to act as a data storage system for the client devices 108. The service application 122 on the service computing device(s) 102 may be executed to receive and store data 124 from the client devices 108 and/or subsequently retrieve and provide the data 124 to the client devices 108. The system 100 may be scalable to increase or decrease the number of service computing devices 102 in the system 100, as desired for providing a particular operational environment. The amount of storage capacity included within the storage(s) 104 can also be scaled as desired. Further, the service computing devices 102 and the client devices 108 may include any number of distinct computer systems, and implementations disclosed herein are not limited to a particular number of computer systems or a particular hardware configuration.

In some examples, the stored data 126 may include a huge amount of data, at least some of which may be stored as data sets 152. For instance, a data set 152 may include a collection of data and one or more corresponding data fields. The data field may be associated with the data of the data set in structured or semi-structured data resource, such as in a table, comma separated value (csv) file, json, xml, parquet, or other data structure. As one example, a column in a csv file may be a field, and may accompany, correspond to, or otherwise be associated with a particular data set 152. Thus, examples herein may tag data that is at least partially structured for automated tagging of the structure portions of the data.

Furthermore, in implementations herein, a data field or a data file may be classified and represented by one or more associated classifications in metadata 135 that may be included in the storage 104 to provide a data catalog. For instance, the metadata 135 may include metadata about each data file or other data set 152 stored in the stored data 126.

The glossary 128 may be a tree data structure that includes classifications (tags) and other information to define characteristics of the stored data 126 and the metadata 135. In some examples, the terms “classification” and “tag” may be used interchangeably. For example, suppose that a given data field is “classified” as a social security number. The data field may also be referred to as being “tagged” as a social security number, with the tag being “social security number”, “SSN” or the like.

Further, the glossary 128 may allow annotations provided by users to be retained as part of the metadata content and which may be included in the glossary 128. These annotations can then be used to enable searching and data understanding. The implementations of tagging and providing annotations described herein may systematically progress towards increasingly higher levels of accuracy. This can lead to a glossary 128 that is partially crowd-sourced. This way the glossary 128 can be created bottom-up in a fashion that can capture and maximize the knowledge of the users without burdening them. Once there is some content in the glossary 128, it can be leveraged to enable users to produce more normalized precise tagging and annotation of data in the storage.

The service application 122 may include an algorithm, as discussed additionally below, that may be executed by the processor(s) 116 to automatically identify target entities in the glossary 128 and the data 126. For example, some terms in the glossary 128 may be just a set of related words, while other terms may additionally indicate how data is laid out in the data 126. Based in part on determining which terms also correspond to data records, this information may be used to perform resource level data classification. The resource level of data classification allows the user to map raw data into processed, easily understandable real-world concepts, thereby bridging any operational gap. This classification process allows the user to work with resources, as opposed to just working with fields, and also provides a context for performing context-driven field-level classification at an increased level of accuracy, by using the determined context to eliminate ambiguous and false positive field classifications (e.g., incorrect tags) that maybe applied to the stored data 126.

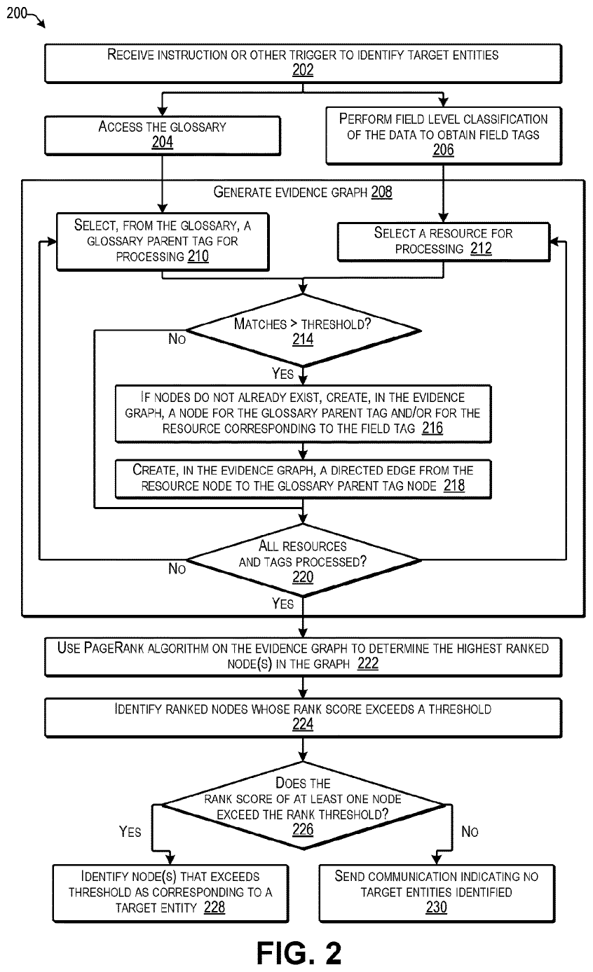

As an example, the algorithm executed by the service computing device 102 may include accessing the glossary 128 and/or using other entity-relationship information that may be available about the data 126 for identifying target entities within the glossary automatically by ranking the glossary terms, resources, and/or tables based on the number of pointed-to relationships in the data 126, such as may be determined from an evidence graph. For instance, the service computing device 102 may initially perform (or may have previously performed) a context-free data classification of all fields. The initial classification stop might not be particularly accurate and does not indicate the final classification results. The service computing device 102 may then construct a weighted evidence graph that encodes evidence from the data 126 for determining that a particular term is a target entity term. After the evidence graph has been constructed, the service computing device 102 may use the PageRank algorithm to identify entity terms by ranking the nodes in the evidence graph and identifying any nodes that have a rank score that exceeds a rank threshold as corresponding to the target entities. Additional details of the algorithm are discussed below, e.g., with respect to FIG. 2.

Furthermore, in some examples herein fingerprints, i.e., tag fingerprints and field fingerprints may be calculated for the data sets herein. Additionally, the tag fingerprints and the field fingerprints for a plurality of data sets may be matched to each other to calculate a score. For instance, a field fingerprint may be a fixed size metadata artifact or other metadata data structure that may be generated for a data set (also referred to as a “field” or “column” in some examples) based on a plurality of data properties of the data in the data set. The field fingerprint may be calculated for the column of data based on a plurality of data properties of the data, such as, but not limited to: top K most frequent values; bloom filters; top K most frequent patterns; top K most frequent tokens; length distribution; minimum and/or maximum values; quantiles; cardinality; row counts; null counts; numeric counts, and so forth. Further, the foregoing data properties are merely examples that may vary in actual implementations, such as depending at least in part on the data type of the data. The tag fingerprints may include one or more field fingerprints of representative data, e.g., aggregated fingerprints.

The fingerprints, i.e., the field fingerprints and the tag fingerprints, are configured such that multiple field fingerprints may be aggregated into a single tag fingerprint. For example, suppose that field F₁ is represented by fingerprint FP₁ and field F₂ is represented by fingerprint FP₂, then the aggregate of these two fingerprints FP₁₂=FP₁+FP₂ may represent both fields F₁ and F₂. This feature of the fingerprints herein provides the ability to accumulate, in the tag fingerprints, both supportive and contradictory fingerprints obtained through a curation process. In some examples, the field fingerprints may be a probabilistic model of a fixed size of the corresponding data set, regardless of the size of the data set. Further, in some cases, the field fingerprints may include one or more bitmaps representative of at least a portion of the data. Because the fingerprints herein are able to be combined together (aggregated) into a single aggregated fingerprint, the single aggregated fingerprint is able to represent multiple data sets in one classification model. Thus, examples herein employ fingerprint-based tags on structured data.

The system 100 is not limited to the particular configuration illustrated in FIG. 1. This configuration is included for the purposes of illustration and discussion only. Various examples herein may utilize a variety of hardware components, software components, and combinations of hardware and software components that are configured to perform the processes and functions described herein. In addition, in some examples, the hardware components described above may be virtualized. For example, some or all of the service computing devices 102 may be virtual machines operating on the one or more hardware processors 116 or portions thereof, and/or other service computing devices 102 may be separate physical computing devices, or may be configured as virtual machines on separate physical computing devices, or on the same physical computing device. Numerous other hardware and software configurations will be apparent to those of skill in the art having the benefit of the disclosure herein. Thus, the scope of the examples disclosed herein is not limited to a particular set of hardware, software, or a combination thereof.

FIG. 2 is a flow diagram illustrating an example process 200 according to some implementations. The process is illustrated as a collection of blocks in a logical flow diagram, which represents a sequence of operations, some or all of which may be implemented in hardware, software or a combination thereof. In the context of software, the blocks may represent computer-executable instructions stored on one or more computer-readable media that, when executed by one or more processors, program the processors to perform the recited operations. Generally, computer-executable instructions include routines, programs, objects, components, data structures and the like that perform particular functions or implement particular data types. The order in which the blocks are described should not be construed as a limitation. Any number of the described blocks can be combined in any order and/or in parallel to implement the process, or alternative processes, and not all of the blocks need be executed. For discussion purposes, the process is described with reference to the environments, frameworks and systems described in the examples herein, although the process may be implemented in a wide variety of other environments, frameworks and systems. For example, the process 200 may be executed by one or more of the service computing devices 102 or other suitable computing devices, such as by execution of the service application 122. Thus, through execution of the service application 122, the computing device may determine one or more target entities based at least on the process below.

At 202, the computing device may receive an instruction or other trigger to identify target entities in the glossary and/or organization data. As one example, a user may send an instruction via a client device 108 that causes the computing device to execute the process 200 for identifying business entities in the glossary or data, such as the data sets 152 discussed above with respect to FIG. 1.

At 204, the computing device may access the glossary 128. In addition, if available, the computing device may access any existing entity-relationships metadata that may be included in the metadata 135. For example, some types of data may include a database schema, or the like, that includes indications of relationships between various data resources.

At 206, the computing device may perform field level classification of the data 126 to obtain field tags for the data. For example, the service application 122 may be executed to perform an automatic inventory of all files or other data sets 152, which may include capturing the lineage, format, and profile of each file or other data set 152, and storing this information in the metadata repository 135. In some cases, the system 100 may deduce the meaning of values in the fields of a data set 152 by analyzing other data sets 152 that have field names with meaningful tags and/or that have been tagged by a user with meaningful tags. For a given data classification (tag) “T”, the system may access or may generate a feature set “Ω_{T}” for a tag classification data model “D_{T}” of the classification T, and a significance vector “A_{T}” for the features of the classification model D_{T}. For instance, for the tag classification model D_{T}, the feature set Ω_{T} may include a plurality of features cᵢ that are relevant to the data in the classification T, e.g.,

$${Ω}_{T} = \{ {c}_{1} , {c}_{2} , … {c}_{n} \}$$

Several example data features may include {field_name, data value, pattern, . . . }, with the particular features being dependent at least in part on the data itself.

Further, the tag classification model D_{T} of the classification T may include computing the features cᵢ on D_{T}, e.g., cᵢ (D_{T}) and may be calculated based on selected reference fields (seeds) and curation results (accepted and rejected classifications). For example, the classification model D_{T} may enable classification and discovery of the data within a large volume of data classified using the glossary 128. The tag classification model D_{T} for classification T for an individual data set may be calculated based on selected reference fields (also referred to herein as “seeds”) and curation results (accepted and rejected classifications). In some examples, tag classification model 127 may include aggregated tag fingerprints 132 for the reference data. In addition, the tag classification model D_{T} may include other data, which may include a feature set based on a tag fingerprint and other metadata that may be useful for classification model matching with field classification models of other data sets. Further, the tag classification model D_{T} may be updated based on curation inputs received from users. As mentioned above, the tag classification model D_{T} may be similar to a field classification model D_{F} (i.e., both use the fingerprints of data of the same size), which enables matching of data based on matching the respective fingerprints and of the respective classification models and of different data sets 152.

In addition, a significance vector of a respective tag classification model D_{T} may indicate the significance of the similarity between features of classified data and unclassified data. Thus, the significance vector may be expressed as, e.g.,

$${A}_{T} = \{ {a}_{1} , {a}_{2} , … {a}_{n} \}$$

where aᵢ indicates the significance of similarity on feature cᵢ. Further, given a known field “F” to be classified with a field classification model D_{F}, the system may calculate a confidence value as to whether F may be classified as T, e.g., whether data corresponding to F should be classified the same as data corresponding to T. To help make this determination, the system may determine a feature similarity score vector, “W_{F,T}”, e.g.,

$${W}_{F , T} = \{ {sim\_c}_{1} ( {D}_{T} , {D}_{F} ) , {sim\_c}_{2} ( {D}_{T} , {D}_{F} ) , … {sim\_c}_{n} ( {D}_{T} , {D}_{F} ) \}$$

which may be simplified as

$${W}_{F , T} = \{ {s}_{1} , {s}_{2} , … {s}_{n} \}$$

where sᵢ=sim_cᵢ(D_{T}, D_{F}). As one example, the similarly score vector may be calculated as a number, and the higher the number, the greater the similarity between respective features of F and T. Based on the feature similarity score vector, the system may determine a similarity score “Score(F,T)” between features of the classified data and the unclassified data, e.g.,

$$Score ( F , T ) = {W}_{F , T} \times {A}_{T} = {a}_{1} \times {s}_{1} + {a}_{2} \times {s}_{2} + … + {a}_{n} \times {s}_{n}$$

One of the goals of the classification techniques herein is to achieve higher confidence levels based on the similarity score(F,T) calculated above, e.g., by continually and iteratively improving the similarity between data classified in the system 100. For instance, the tag classification models D_{T} may be updated based on updates to the tag fingerprints and other data, such as collected statistics. The updates may be performed in a feature specific manner for two classes of features, namely supportive and contradictory. Furthermore, the significance vector A_{T} affects the confidence level for classification associations. For example, different updates to the tag classification model D_{T} and to the similarity score(F,T) are performed based on the significance vector for accepted associations and rejected associations and for supportive and contradictory features, e.g., aᵢ=f_accepted(av, score, reward) for supportive features and aᵢ=f_rejected(av, score, penalty) for contradictory features.

At 208, the computing device may generate an evidence graph by performing the operations of blocks 210-220.

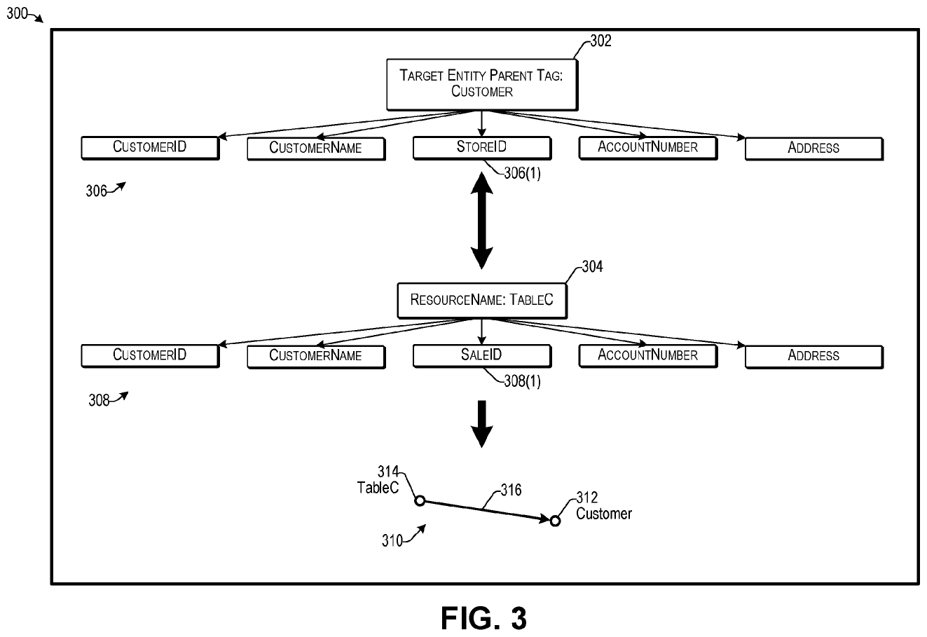

At 210, the computing device may select a glossary target entity parent tag from the glossary for processing. An example of a glossary parent tag is described below, e.g., with respect to FIG. 3. For instance, the glossary parent tag may be associated with a business entity or other target entity.

At 212, the computing device may select, from the data 126, a resource for processing, including the field tags associated with the resource as determined at 206. An example of field tags associated with a selected resource is described below, e.g., with respect to FIG. 3.

At 214, the computing device may compare the selected glossary parent tag with the selected resources to determine whether a number of matches between child tags of the selected parent tag and child field tags of the selected resource exceeds a matching threshold. If the number of matches exceeds the matching threshold, the process goes to 216. If not, the process goes to 220. An example of comparing a glossary parent tag with the field tags of a selected resource is described below, e.g., with respect to FIG. 3.

At 216, when the matches exceed the threshold and, if nodes do not already exist in the evidence graph for the selected glossary parent tag and/or for the selected resource, the computing device may create, in the evidence graph, a node for the glossary parent tag and/or a node for the selected resource, respectively.

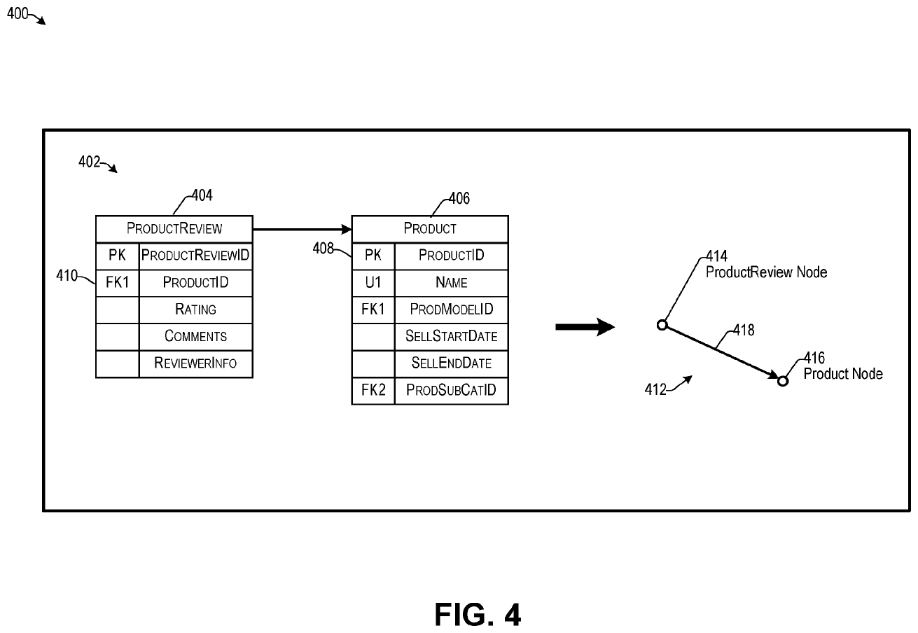

At 218, the computing device may create, in the evidence graph, a directed edge from the resource node to the glossary parent tag node. In some examples, the directed edge is also weighted based on an importance measure that may be determined for the relationship between the two nodes. An example of determining a weighting for an edge is discussed below, e.g., with respect to FIG. 4.

At 220, the computing device may select a next resource for comparison with the selected glossary parent tag. When all resources have been compared with the selected glossary parent tag, a next glossary parent tag may be selected for processing and the system may repeat the process of comparing tags of all resources with the currently selected glossary parent tag. The process may continue until all glossary parent tags in the glossary 128 have been compared to the field tags of all the data resources in the data 126.

At 222, when all data resources and all parent tags in the glossary have been processed, the computing device may use the PageRank algorithm on the evidence graph to determine the highest ranked nodes in the evidence graph. The PageRank algorithm, by its function, considers both evidence and counter evidence in determining the respective ranks of the nodes in the evidence graph.

At 224, the computing device may identify nodes whose rank score, as determined by the PageRank algorithm, exceeds a rank threshold.

At 226, the computing device may determine whether the rank score of at least one node in the evidence graph exceeds the rank threshold. If so, the process goes to 228. If not, the process goes to 230.

At 228, the computing device may identify the node(s) that exceeds the rank threshold as corresponding to a target entity, such as a business entity. In particular, the tags of a node that has a rank score that exceed the threshold correspond to the target entity. As mentioned above, the identification of target entities, such as business entities (e.g., business-related terms or the like), enables more powerful searching in a data catalog. For example, the identification of business entities in the glossary can be used to perform resource-level data classification. This level of data classification allows the user to map the user's raw data into processed, easily understandable and/or recognizable real-world concepts, and bridges an operational gap, thereby enabling the searching of resources based on business entity tags. Furthermore, based on the business entity identification, it becomes possible for the catalog to provide context for other downstream cataloging tasks such as for enabling disambiguation of ambiguous tags. As one example, three-digit numbers which are inherently anonymous and therefore could potentially be tagged with a multitude of tags, may be associated with a business entity tag, such a CVV to provide context and limit the tags associated with these numbers. Accordingly, the identification of the business entities can also serve as a context for more accurate field level classification of data. Furthermore, without the automated technique for discovering business entities as described herein, a user would conventionally have to perform manual identification of business entity terms, which is not reasonably scalable for large databases or other large collections of data.

At 230, when the results of the PageRank algorithm indicate that none of the nodes in the evidence graph exceed the rank threshold, the computing device may send a communication indicating that there are no target entities that have been identified in the glossary that reflects in the data.

FIG. 3 illustrates an example 300 of comparing a glossary target entity parent tag with a selected resource according to some implementations. For example, the parent tags may have been previously added to the glossary during creation of the glossary, such as by a user, an algorithm, a machine-learning classifier, or the like. As discussed above with respect to FIG. 2, when constructing the evidence graph, the service computing device may compare a selected glossary parent tag with the field tags determined for a selected resource to determine whether a number of matches between the selected glossary parent tag and the selected resource exceeds a matching threshold. In the illustrated example, suppose that the service computing device is comparing a selected glossary parent tag 302 “Customer” with a field tag 304 of a resource having a resource name “TableC”. In this example, the glossary parent tag 302 has a plurality of glossary child tags 306, namely “CustomerID”, “CustomerName”, “StoreID”, “AccountNumber”, and “Address”. Furthermore, the field tag 304 also has a plurality of child tags 308, namely “CustomerID”, “CustomerName”, “SaleID”, “AccountNumber”, and “Address”. Consequently, based on the comparison, the service computing device may determine that the StoreID glossary child tag 306(1) does not match any tag in the resource child tags 308 and that the SaleID child tag 308(1) does not match any tag in the glossary child tags 306. Accordingly, the intersection of child tags 306 of the glossary parent tag 302 with the child tags 308 of the field tag 304 is 4 out of a total of 5 glossary child tags, and accordingly, the intersection is 80 percent or 0.8. Further, in this example, suppose that the match threshold is 70 percent or 0.7.

As indicated at 310, because the intersection (number of matches) exceeds the match threshold, if nodes do not already exist in the evidence graph for the selected glossary parent tag 302 and/or for the selected resource 304, the service computing device may create, in the evidence graph, a node 312 for the glossary parent tag and/or a node 314 for the selected resource, respectively. In addition, a new directed edge 316 is added to the evidence graph that is directed from the resource node 314 to the glossary parent tag node 312.

FIG. 4 illustrates an example 400 of creating a portion of the evidence graph based on a relationship determined from a database schema according to some implementations. For example, suppose that a portion of a database schema 402 includes a product review table 404 and a product table 406. Further suppose that there is a Primary Key-Foreign Key (PK-FK) relationship between the product review table 404 and the product table 406. For instance, the PK 408 of the product table 406 may be “ProductID” and the FK1 410 of the product review table 404 is also “ProductID”. Consequently, based at least on this relationship, a portion 412 of the evidence graph may be generated to include a product review node 414 corresponding to the product review table 404 and a product node 416 corresponding to the product table 406. Further, based on the PK-FK relationship, a directed edge 418 may be established between the product review node 414 and the product node 416.

Additionally, in some examples, weights may be associated with some or all of the edges in the evidence graph. For example, a weight of 1.0 may be applied to edges determined based on database schema, such as in the example of FIG. 4, while a weight of 0.8 might be applied to the edge 316 in the example of FIG. 3. For instance, the association in the example of FIG. 3 may be perceived to be lower confidence than that of FIG. 4 since there was only an 80 percent match in the example of FIG. 3. As another example, a first weight is applied to edges derived from an entity relationship diagram schema, and a second, different weight is applied to edges determined from matching tag intersections.

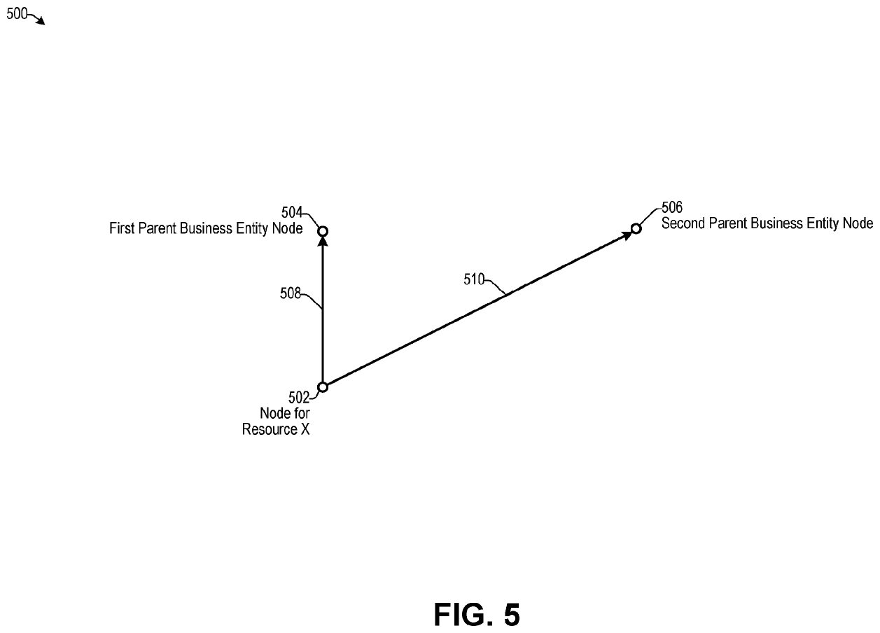

FIG. 5 illustrates an example evidence graph portion 500 according to some implementations. In this example, suppose that the three nodes are included in the evidence graph portion 500, namely a node 502 four a resource X, a node 504 for a first parent business entity node, and a node 506 for a second parent business entity node. Further, a first directed edge 508 extends from node 502 to node 504, and a second directed edge 510 extends from node 502 to node 506.

For example, suppose that the resource X field tags matched the tags of the first parent business entity node 504 and the second parent business entity node 506 by an amount that exceeded the matching threshold. Accordingly, when the page ranking algorithm is executed for the evidence graph that includes the portion 500, the directed edge 508 acts as evidence against the directed edge 510, and vice versa, the directed edge 510 acts as evidence against the directed edge 508. Accordingly, implementations herein, through the manner of constructing the evidence graph and through use of the page ranking algorithm automatically take into account counter evidence when performing the ranking of the nodes for identification of target entities.

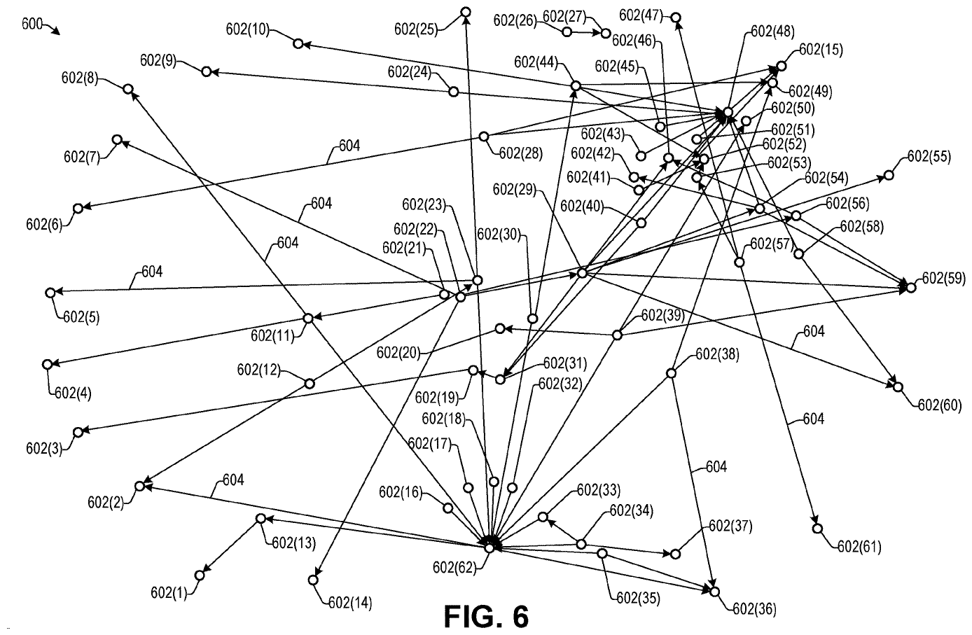

FIG. 6 illustrates an example evidence graph 600 that may be constructed according to implementations herein. The evidence graph 600 presents a set of pointed-to relationships from respective resources to respective glossary tags. The evidence graph 600 sets forth evidence that a given resource maps to a glossary tag and, therefore, after the page rank processing has been performed, provides the evidence that one or more highest ranked glossary tags are business entities.

In the illustrated example, the evidence graph 600 includes a plurality of nodes 602(1) through 602(62) and a plurality of directed edges 604 connecting various ones of the nodes 602. As discussed above, e.g., with respect to FIGS. 2-5, each node 602 may represent either a parent business entity node or a field tag associated with a data resource. Thus, each directed edge 604 may indicate a relationship between a respective field tag associated with a data resource and a corresponding business entity tag.

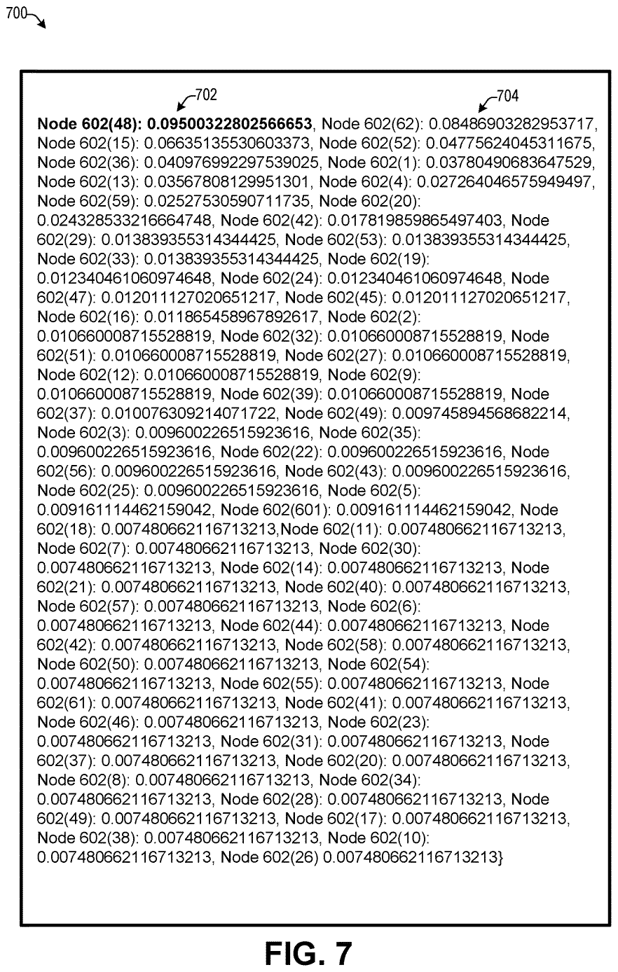

FIG. 7 illustrates an example output 700 of the applying the PageRank algorithm to the evidence graph of FIG. 6 according to some implementations. In this example, the PageRank algorithm has been executed to rank the values of the individual nodes 602(1)-602(62) based on the number of other nodes 602(1)-602(62) that refer to them. In this example, as indicated at 702, node 602(48) from the evidence graph 600 has the highest rank score as determined by the PageRank algorithm. In this example, the score is “0.095” (rounded to three decimal places). As one example, suppose that the rank score threshold has been set by the user to be 0.090. Consequently, as the score of node 602(48) exceeds the ranking threshold, the tags associated with node 602(48) are identified as target entities, e.g., business entities in some examples.

Furthermore, in the illustrated example, the second highest ranked node is node 602(62), having a rank score of “0.085” (rounded to three decimal places). Based on this rank score being less than the rank score threshold of 0.090, node 602(62) is not identified as having target entity tags. Similarly, none of the other nodes 602 in the evidence graph 600 have a rank score that exceeds the rank score threshold.

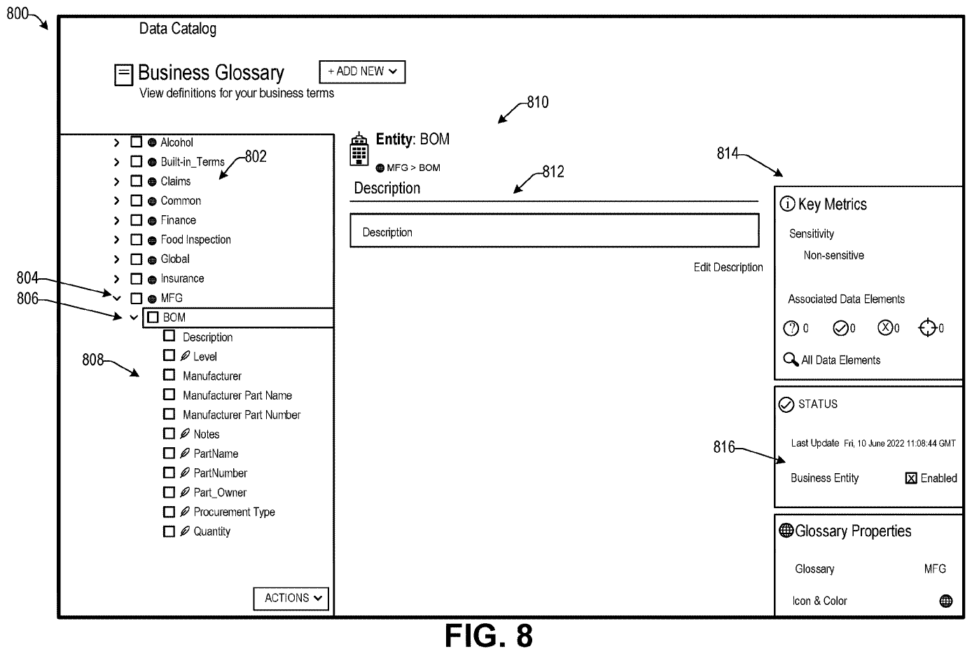

FIG. 8 illustrates an example user interface 800 for managing the glossary herein according to some implementations. For instance, the user interface 800 may be provided by the service application 122 to one or more of the client devices 108 to cause the client application 136 to present the user interface 800 on a display associated with the client device 108. In this example, the user interface 800 includes a list 802 of top level tag domains on the left side. Additionally, as indicated at 804, the manufacturing (MFG) tag has been selected by the user, and is therefore highlighted.

Further, based on the MFG tag having been selected a bill of materials (BOM) tag is presented at 806. For instance, the BOM tag may be a child tag of the MFG tag and a parent tag of a plurality of other tags, as indicated at 808, such as at Description tag, a Level tag, a Manufacturer tag, a Manufacturer Part Name tag, a Manufacturer Part Number tag, and so forth, each of which may be considered at a child tag to the parent tag BOM. Additionally, in this example, the BOM tag has been selected by the user, which results in presentation in the user interface 800 of additional information related to the selected tag, as indicated at 810, 812, and 814. For instance, a description tag may be edited at 812 to provide a description of the business entity BOM. Further in this example, the BOM tag and its children have been designated as business entities, as indicated at 816.

In some examples herein, the glossary is not modified as a result of the business entities therein being identified, but the user interface 800 is able to present a separate visual that has only the glossary terms that have been identified as belonging to business entities. From this visual information, the search facility may be employed to search the data resources by business entity. Additionally, in some examples, a feedback loop may be implemented based on the business tags discovered, and may be used to disambiguate ambiguous/anonymous tags based on the business entity to which the tagged data belongs. Accordingly, the examples herein may identify data that has been mis-tagged, and may correct the tags associated with the mis-tagged data based on association with an identified business entity tag.

The example processes described herein are only examples of processes provided for discussion purposes. Numerous other variations will be apparent to those of skill in the art in light of the disclosure herein. Further, while the disclosure herein sets forth several examples of suitable frameworks, architectures and environments for executing the processes, the implementations herein are not limited to the particular examples shown and discussed. Furthermore, this disclosure provides various example implementations, as described and as illustrated in the drawings. However, this disclosure is not limited to the implementations described and illustrated herein, but can extend to other implementations, as would be known or as would become known to those skilled in the art.

Various instructions, processes, and techniques described herein may be considered in the general context of computer-executable instructions, such as program modules stored on computer-readable media, and executed by the processor(s) herein. Generally, program modules include routines, programs, objects, components, data structures, executable code, etc., for performing particular tasks or implementing particular abstract data types. These program modules, and the like, may be executed as native code or may be downloaded and executed, such as in a virtual machine or other just-in-time compilation execution environment. Typically, the functionality of the program modules may be combined or distributed as desired in various implementations. An implementation of these modules and techniques may be stored on computer storage media or transmitted across some form of communication media.

Although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

1. A system comprising:
one or more processors configured by executable instructions to perform operations comprising:
receiving a tree data structure representing a plurality of tags arranged in a hierarchy indicating a business level of abstraction;
executing a field level classification of data to obtain field tags related to the data;
generating a graph data structure by:
matching field tags of the data to a set of child tags of the tree and creating a first node in the graph data structure for at least a parent tag of the set of child tags and a second node in the graph data structure for a resource in the data corresponding to the field tags;
based on at least one of an amount of matching between the field tags and the set of child tags, or one or more entity relationships, creating, in the graph data structure, a directed edge from the second node to the first node; and
repeating the matching and the creating for a plurality of the parent tags and a plurality of the resources in the data to generate the graph data structure; and
executing a ranking algorithm on the graph data structure to determine at least one of the first nodes having a rank that exceeds a rank threshold.

2. The system as recited in claim 1, wherein matching the field tags of the data to the set of child tags of the tree includes determining that an amount of the matching exceeds a matching threshold.

3. The system as recited in claim 1, the operations further comprising applying a weighting to one or more of the directed edges of the graph data structure, the weighting affecting a ranking score of a first node pointed to by the weighted directed edge during execution of the ranking algorithm.

4. The system as recited in claim 1, the operations further comprising designating a parent tag corresponding to the at least one first node as a business entity.

5. The system as recited in claim 4, the operations further comprising designating one or more child tags of the parent tag as business entities.

6. The system as recited in claim 1, further comprising a database schema, wherein determining the graph data structure further comprises determining relationships between resources in the database schema, wherein a third node in the graph data structure corresponds to one of the resources in the schema and a fourth node corresponds to another one of the resources in the schema.

7. The system as recited in claim 6, wherein determining relationships between the resources in the schema comprises identifying a Primary Key-Foreign Key relationship between the resources in the schema.

8. The system as recited in claim 1, the operations further comprising removing at least one false positive field tag from being associated with the data based on a tag associated with the at least one first node having the rank that exceeds the rank threshold.

9. The system as recited in claim 1, wherein the ranking algorithm takes into account evidence and counter-evidence for the parent tag.

10. The system as recited in claim 1, the operations further comprising sending, to a client computing device, user interface information to cause the client device to present information related to at least one of the identified target entities in a user interface on a display associated with the client computing device.

11. The system as recited in claim 1, wherein executing the field level classification of data comprises determining a similarity score between features of already classified data and features of unclassified data.

12. A method comprising:
receiving, by one or more processors, a tree data structure representing a plurality of tags arranged in a hierarchy indicating a business level of abstraction;
executing a field level classification of data to obtain field tags related to the data;
generating a graph data structure by:
matching field tags of the data to a set of child tags of the tree and creating a first node in the graph data structure for at least a parent tag of the set of child tags and a second node in the graph data structure for a resource in the data corresponding to the field tags;
based on at least one of an amount of matching between the field tags and the set of child tags, or one or more entity relationships, creating, in the graph data structure, a directed edge from the second node to the first node; and
repeating the matching and the creating for a plurality of the parent tags and a plurality of the resources in the data to generate the graph data structure; and
executing a ranking algorithm on the graph data structure to determine at least one of the first nodes having a rank that exceeds a rank threshold.

13. The method as recited in claim 12, wherein matching the field tags of the data to the set of child tags of the tree includes determining that an amount of the matching exceeds a matching threshold.

14. One or more non-transitory computer-readable media storing instructions that, when executed by one or more processors, configure the one or more processors to perform operations comprising:
a tree data structure representing a plurality of tags arranged in a hierarchy indicating a business level of abstraction;
executing a field level classification of data to obtain field tags related to the data;
generating a graph data structure by:
matching field tags of the data to a set of child tags of the tree and creating a first node in the graph data structure for at least a parent tag of the set of child tags and a second node in the graph data structure for a resource in the data corresponding to the field tags;
based on at least one of an amount of matching between the field tags and the set of child tags, or one or more entity relationships, creating, in the graph data structure, a directed edge from the second node to the first node; and
repeating the matching and the creating for a plurality of the parent tags and a plurality of the resources in the data to generate the graph data structure; and
executing a ranking algorithm on the graph data structure to determine at least one of the first nodes having a rank that exceeds a rank threshold.

15. The one or more non-transitory computer-readable media as recited in claim 14, wherein matching the field tags of the data to the set of child tags of the tree includes determining that an amount of the matching exceeds a matching threshold.
